(19) United States
(12) Patent Application Publication
(10) Pub. No.: US 2006/0289606 A1
(43) Pub. Date: Dec. 28, 2006

(54) Monitoring in tube production

(76) Inventor: David R. Taylor, Fairbury, IL (US)

Correspondence Address: REED SMITH LLP, P.O. BOX 488, PITTSBURGH, PA, 15230-0488, US

(21) Appl. No.: 11/166,018

(22) Filed: Jun. 23, 2005

(51) Int. Cl. B23K 13/08; B23Q 15/00; B23K 31/12

(52) U.S. Cl. 228/8; 228/103

(57) ABSTRACT

Preliminary weld seam integrity testing in tube production. In a preferred embodiment, an “ovaling pass” station helps subject a tube to weld seam integrity testing that can ferret out weld seam problems much more reliably than with conventional technology, and at a comfortably early juncture. Particularly, after a tube has been formed and welded, an “ovaling pass” station will preferably be employed to cause the tube to become slightly oval in cross-sectional configuration to thus create a concentrated stress along the actual tube weld line. A sizing pass is then preferably employed to impart once again the desired, substantially constant circular cross-section with substantially constant diameter, after which conventional testing (such as eddy current testing) may take place.

### FIELD OF THE INVENTION

The present invention generally relates to methods and arrangements for effecting quality control in tube production.

### BACKGROUND OF THE INVENTION

Typically, in longitudinal-weld tube production, quality control is supremely important if only because of the need to ensure the integrity of the weld seam. Historically, one method for testing longitudinal weld seams has been through eddy current testing. Typically, tubes that have been formed and welded will progress through a conventional eddy current testing arrangement to ascertain whether one or more tubes possesses cold weld cracks and, thus, may be a candidate for rejection. As needed, tubes are accordingly rejected.

While the above quality control procedure is known to provide for the rejection of defective tubes, it has been found that such efforts are often not fully sufficient. Particularly, it is often the case that tubes will pass inspection that in fact end up failing at a later juncture, owing to undetected spot weaknesses along the weld seam or other failures.

Accordingly, a need has been recognized in connection with providing a more effective method for ascertaining and rejecting tubes with faulty weld seams, to the point of ensuring greater weld seam integrity in tubes that are not rejected.

### SUMMARY OF THE INVENTION

In accordance with at least one presently preferred embodiment of the present invention, there is broadly contemplated an arrangement whereby preliminary weld seam integrity testing is undertaken.

In a preferred embodiment of the present invention, an “ovaling pass” station helps subject a tube to weld seam integrity testing that can ferret out weld seam problems much more reliably than with conventional technology, and at a comfortably early juncture. Particularly, after a tube has been formed and welded, an “ovaling pass” station will preferably be employed to cause the tube to become slightly oval in cross-sectional configuration (i.e., to transform a tube with a substantially circular cross-section, having a substantially constant diameter, to one having a generally oval cross-section, with a maximum diameter in one direction and a minimum diameter in an orthogonal direction). More particularly, the “ovaling pass” will normally be so configured as to create a concentrated stress along the actual tube weld line, e.g., by ensuring that the weld line corresponds to a line on the tube at a point of maximum diameter.

A “sizing pass” is then preferably employed to impart once again the desired, substantially constant circular cross-section with substantially constant diameter, after which conventional testing (such as eddy current testing) may take place. In this case, of course, a primary difference is that only tubes with fully intact welds will likely avoid rejection.

In summary, there is broadly contemplated, in accordance with at least one presently preferred embodiment of the present invention, an apparatus for weld seam integrity testing for tubing, the arrangement comprising: an arrangement for receiving a tube; an arrangement for testing a tube; and an arrangement for rejecting at least one tube; the testing arrangement being adapted to: alter a configuration of a tube; thereafter re-form the tube substantially back to an original shape; and thereafter ascertain weld seam integrity of the tube.

Additionally, there is broadly contemplated, in accordance with at least one presently preferred embodiment of the present invention, a method for weld seam integrity testing for tubing, the method comprising: receiving a tube; testing a tube; and rejecting at least one tube; the testing step comprising: altering a configuration of a tube; thereafter re-forming the tube substantially back to an original shape; and thereafter ascertaining weld seam integrity of the tube.

### BRIEF DESCRIPTION OF THE DRAWINGS

The present invention and its presently preferred embodiments will be better understood by way of reference to the detailed disclosure herebelow and to the accompanying drawings, wherein:

FIG. 1 schematically illustrates an arrangement for weld seam integrity testing.

FIG. 2 illustrates a weld seam testing arrangement in greater detail.

### DESCRIPTION OF THE PREFERRED EMBODIMENTS

Longitudinal-weld tube forming processes are generally very well-known to those of ordinary skill in the art, and basic details regarding the same need not be repeated here. The well-known ASTM A513 specification provides details of conventional cold-weld tube forming processes that could be associated with at least one embodiment of the present invention.

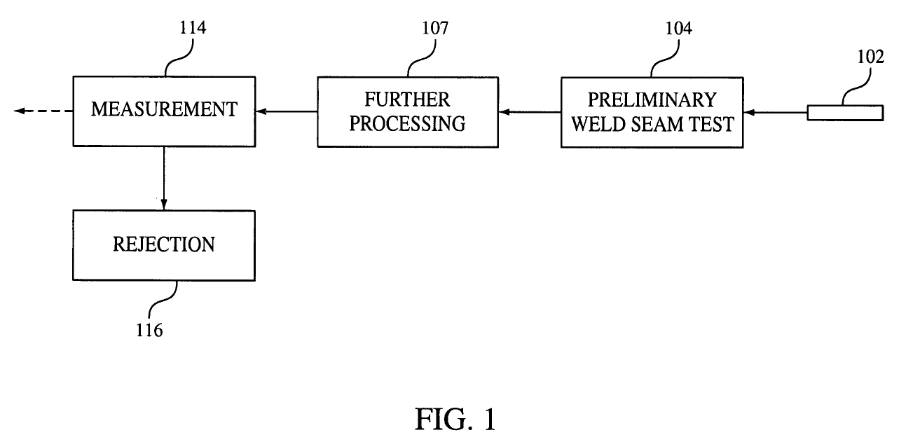

FIG. 1 schematically illustrates an arrangement for preliminary weld seam integrity testing. As shown, an elongated tube 102 which has already been formed and welded may be fed to an arrangement 104 for carrying out a preliminary weld seam integrity test, such as a preliminary stress test. Further tube processing may take place at 107 (including, e.g., cutting and blow-off) followed by automatic measurement at 114 (e.g., via eddy current testing), at which point one or more tube lengths may be rejected (116).

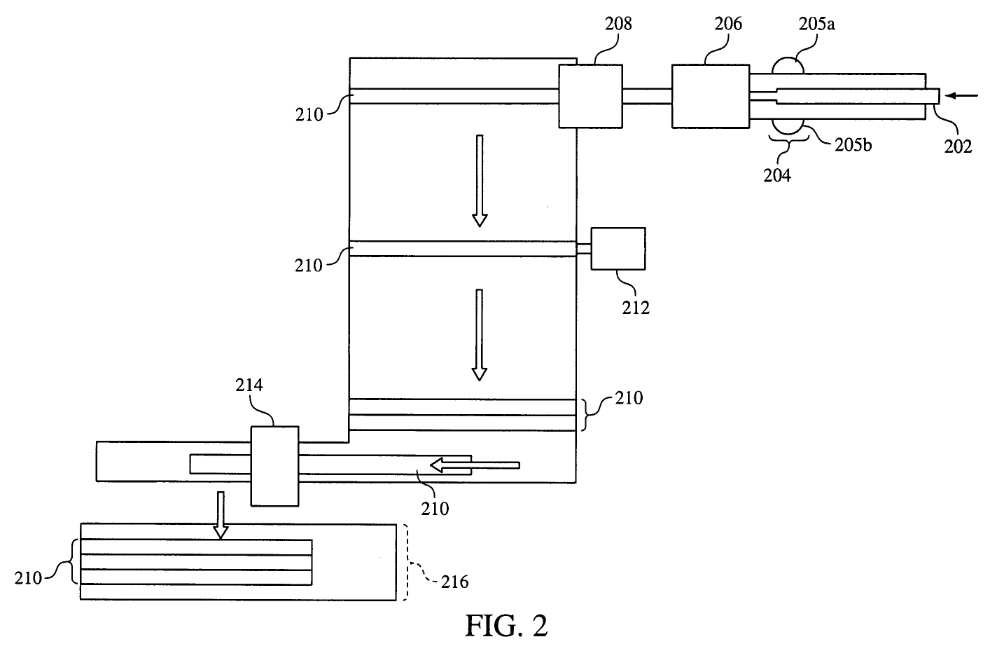

FIG. 2 illustrates a presently preferred embodiment of the present invention in more detail. As shown, an ovaling pass station 204 may be provided to accept a tube 202 that has been formed and welded. In a particularly preferred embodiment, “ovaling” can be carried out via the simple provision of opposing rollers (such as those indicated at 205a and 205b). The opposing rollers 205a/b may then act to apply a compressive force and thus “squeeze” the tube such that, in a direction defined directly between the points of contact of the rollers, the tube will assume a minimum diameter while in an orthogonal direction the tube will assume a maximum diameter. Preferably, the tube will have been already oriented such that the weld seam ends up corresponding to a line along the length of the tube that is located at this maximum diameter, to thereby ensure that the weld seam is subjected to the maximum concentrated stress as a result of the ovaling pass.

With regard to the ovaling process, it should be recognized that there will likely be a limit to the degree of external pressure that can be applied to the tube. However, it will also be recognized that this is dependent upon the tube diameter, wall thickness, the material used, and the feeding speed, which can easily be determined and tailored to.

Though the use of opposing rollers is cited herein as a preferred method of ovaling, it should be recognized that a wide variety of processes are also contemplated and foreseen for the ovaling process that may be somewhat different in function but yield substantially the same result. Essentially, such alternative processes could preferably involve the general application of a compressive force to substantially diametrically opposing regions about a tube circumference. Such a force could preferably be applied from two generally opposing directions, but could even be applied from just one direction while resistance is provided from an opposing direction.

As shown, after the ovaling pass 204, the tube preferably progresses to a conventional sizing pass station 206 whereby the tube is re-formed substantially back to its original cross-sectional configuration. (Prior to ovaling, looser tolerances are permissible than in the case of the final product.) Subsequent to this, there is preferably a typical cut-off station 208 where the tube is now cut into lengths 210. As generally known, a typical blow-off station 212 may then be present for blowing out the ID (inner diameter) “scarf” that is sheared from the inside of the tube (though it is of course recognized that some operations might not need to involve this step).

At this point, there is preferably provided the opportunity to measure or ascertain the integrity of the longitudinal weld seams that were subjected to a stress test in the ovaling pass station 206. An automatic arrangement 214 is thus preferably provided for carrying out such checks. In this respect, it is possible to check virtually every tube length 210 that has been formed and cut and to do so relatively quickly.

In a preferred embodiment of the present invention the automatic arrangement 214 is embodied by an eddy current testing device. Essentially any suitable conventional eddy current testing device would suffice for this purpose. Preferably, each tube length will be fed in a longitudinal direction through the device 214 so that the entire length of the weld seam for each tube length may be checked. Defective tubes may then be rejected (e.g., in a subsequent rejection station 216).

If not otherwise stated herein, it may be assumed that all components and/or processes described heretofore may, if appropriate, be considered to be interchangeable with similar components and/or processes disclosed elsewhere in the specification, unless an express indication is made to the contrary.

If not otherwise stated herein, any and all patents, patent publications, articles and other printed publications discussed or mentioned herein are hereby incorporated by reference as if set forth in their entirety herein.

It should be appreciated that the apparatus and method of the present invention may be configured and conducted as appropriate for any context at hand. The embodiments described above are to be considered in all respects only as illustrative and not restrictive. All changes which come within the meaning and range of equivalency of the claims are to be embraced within their scope.

1-12. (canceled)

13. A method for weld seam integrity testing for tubing, said method comprising:
receiving a tube; and
testing a tube;
said testing step comprising:
altering a configuration of a tube;
thereafter re-forming the tube substantially back to an original shape; and
thereafter ascertaining weld seam integrity of the tube.

14. The method according to claim 13, wherein said receiving step comprises receiving a tube with a longitudinal weld seam.

15. The method according to claim 13, wherein said testing step comprises imparting a substantially oval cross-sectional shape to a tube.

16. The method according to claim 15, wherein said ovaling step comprises applying a compressive force to a tube.

17. The method according to claim 16, wherein said step of applying a compressive force comprises applying a force at opposite regions with respect to a circumference of a tube.

18. The method according to claim 17, wherein said compressive force providers comprise a pair of rollers adapted to apply a compressive force at opposite regions with respect to a circumference of a tube.

19. The method according to claim 17, wherein said step of applying a compressive force comprises applying a compressive force to a tube such that, in a direction defined directly between the points of contact of the compressive force providers, the tube will assume a minimum diameter while in an orthogonal direction the tube will assume a maximum diameter.

20. The method according to claim 19, wherein a weld seam of the tube is substantially located at a region of maximum tube diameter.

21. The method according to claim 13, wherein said testing arrangement comprises automatically testing the integrity of a tube weld seam.

22. The method according to claim 21, wherein said step of automatically testing comprises utilizing an eddy current testing arrangement.

23. The method according to claim 21, wherein said step of automatically testing comprises accepting a tube length along a general longitudinal dimension of a weld seam.

24. The method according to claim 25, wherein said rejecting step comprises rejecting a tube length based on testing in said step of automatically testing.

25. The method according to claim 13, further comprising the step of rejecting a tube.
